(19) United States
(12) Patent Application Publication
(10) Pub. No.: US 2026/0111789 A1
(43) Pub. Date: Apr. 23, 2026

(54) LOSS FUNCTIONS BASED ON STOCHASTIC INDEPENDENCE

(71) Applicant: SAP SE, Walldorf (DE)

(72) Inventors: Saleh GHOLAM ZADEH, Heidelberg (DE); Tim Breitenbach, Mitgenfeld (DE)

(21) Appl. No.: 18/920,037

(22) Filed: Oct. 18, 2024

(51) Int. Cl. G06N 20/00

(52) U.S. Cl. CPC G06N 20/00

(57) ABSTRACT

In various implementations, the techniques may include accessing a machine learning model, input and output ground-truth data. The techniques may include determining model deviation values between output data and the ground-truth data. The techniques may include determining a stochastic dependence value between the input data and the model deviation values using a loss function. The techniques may include training the model to reduce the stochastic dependence value below a predefined threshold value. The techniques may include determining a probability value indicating an existence of further deterministic relations to extract. If the stochastic dependence value is above the predefined threshold value, the techniques may continue training the model. If the stochastic dependence value is at or below the predefined threshold value or the probability value is greater than, less than, or equal to a predefined probability value the techniques can include storing the one or more weights the trained model.

### BACKGROUND

In a machine learning (ML) scenario an input-output relationship can be predicted using a machine learning model. However, users may wish to determine the degree to which a particular model can predict the output given the provided input because circumstances may exist in which not all information for an accurate prediction may be contained in the input data. A machine learning model may only be provided with the historical data p(t), in order to predict the future of this quantity, however, to successfully do so further information may be necessary modeled by q(t) which is not to provided to the model. Consequently, this relationship can be represented by the following equation: p(t+δt)=f(p(t), q(t)).

In some non-limiting examples, predicting a financial index or predicting network traffic may depend on multiple variables. Additionally, user behavior may affect future output. The future of input-output relation may not be learned by the model because it may not exist in the historical data. The data acquisition may also be noisy which can obscure the input-output-relationships. It would be advantageous to determine a model that not only can quantify the amount of reliable extractable information but also can extract most of the deterministic relations between input and output.

Models can be trained to extract deterministic information or relations respectively. As part of that training, the input data (x), ground truth data, and model prediction data can be analyzed to determine the independence between the input data and the model deviation data. In common machine learning techniques training only involves minimizing the distance between the model output and the ground truth data.

Loss functions (e.g., L2, L1, cross-entropy and KL-divergence) may only optimize the distance between each sample and the output of a model regardless of if some relations are governed by dynamics unpredictable given the input. For example, if for a certain kind of input, the output can be noisy compared to other samples governed by a highly deterministic relation, these loss-functions do not make any difference regarding deterministic relations, noise or other relations not predictable from the input. The result may be that the model is prone to noise in the data while it lowers its performance for an accurate prediction based on the predictable parts. This may limit the capability in particular for new and unseen data.

These classical loss functions do not provide information about the best accuracy that is achievable assuming that not all output variables can be totally predicted given the input data, as illustrated with the example from the beginning.

As outlined, the input-output-relation consists of predictable and unpredictable parts. Consequently, the model training needs to be able to differentiate to focus on the predictable part of the data, and optimize its parameters accordingly, i.e., trained to extract all the deterministic relations.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a computer implemented method may include accessing the machine learning model and input data for the machine learning model. The computer implemented method may include determining model deviation values between output data of the machine learning model and the ground-truth data. The model deviation values can be generated by a function that describes a deviation of the output data from the ground-truth data.

The computer implemented method may include designing a loss function measuring a stochastic dependence value between the input data and the model deviation values of the machine learning model.

The computer implemented method may in addition include training the machine learning model to reduce a loss function's stochastic dependence value below a predefined threshold value. The computer implemented method may moreover include determining a probability value indicating an existence of further deterministic relations to extract. The probability value can indicate further change of the loss value is not meaningful any more using a distribution of loss function values in case of independent input data and model deviation values. If the stochastic dependence value is above the predefined threshold value, the computer implemented method may continue training the machine learning model to reduce the loss function value below the predefined threshold value. The training of the machine learning model can include manipulating one or more weights to minimize the information theoretic measure such as stochastic dependence or mutual information between the residual or model deviation and input data.

If the stochastic dependence value is at or below the predefined threshold value or the probability value is greater than, less than, or equal to a predefined probability value, the computer implemented method may include storing one or more weights calculated during the training the machine learning model, and storing the trained machine learning model. Other embodiments of this aspect include corresponding computer systems, apparatus, and computer programs recorded on one or more computer storage devices, each configured to perform the actions of the methods.

Implementations may include one or more of the following features. In various embodiments, determining the model deviation values can be calculated as a difference between the model output data and the ground-truth data for ordinal data types. In various embodiments, the ordinal data types may include categorical and continuous data that has a ranking. The ranking can be among various categories. In various embodiments, a difference between each rank can be quantified. In various embodiments, determining the model deviation values for nominal data can be calculated using a difference of a predicted probability distribution over different classes (model output) and a ground-truth distribution. In various embodiments, nominal data may include variables used to categorize data without any ranking, meaning which cannot be ordered according to size of numbers and distance between the numerical representations have no meaning. In various embodiments, the method may include smoothing the loss function with regard to the output data. In various embodiments, the method may include testing the trained machine learning model using the one or more weights and the input data. Implementations of the described techniques may include hardware, a method or process, or a computer tangible medium.

The following detailed description and accompanying drawings provide a better understanding of the nature and advantages of various embodiments of the present disclosure.

### BRIEF DESCRIPTION OF THE DRAWINGS

FIG. 1 illustrates a system for evaluating a machine learning model.

FIG. 2 is an exemplary flow chart of a process, according to an example of the present disclosure.

FIG. 3 illustrates an exemplary computer system for implementing various embodiments described above.

FIG. 4 illustrates an exemplary computing device for implementing various embodiments described above.

FIG. 5 illustrates an exemplary system for implementing various embodiments described above.

### DETAILED DESCRIPTION

In the following description, for purposes of explanation, numerous examples and specific details are set forth to provide a thorough understanding of the present disclosure. It will be evident, however, to one skilled in the art that various embodiments of the present disclosure as defined by the claims may include some or all of the features in these examples alone or in combination with other features described below and may further include modifications and equivalents of the features and concepts described herein.

Described herein are techniques for evaluating a machine learning model. In various aspects, the system can evaluate an input-output relationship of the machine learning model. The disclosed techniques provide use of a loss function to determine and minimize the stochastic dependence between an input (x), and the deviation between the model output, and ground truth data. The techniques involve adapting the parameters of a machine learning model such that the deviation from the ground truth is independent of the input data (x). Therefore, when one knows the input to the machine learning model, the deviation between the model output data and the ground truth data, i.e., error is not predictable and thus is not correctable anymore. In this way, the model has extracted everything it can from the data (e.g., any reliable, deterministic connection between input data and ground truth output data). By accounting for the input data, the information theoretic loss function can take the input data and the model deviation into account.

In various embodiments, the information theoretic loss functions that can be implemented are the mutual information loss function and the Chi Square loss functions.

Data analysis and the application of the corresponding insights work if there are reliable and stable relations between the measured quantities and the machine learning model. However, because any measurement may not be error free or the dynamics that determine the values of the considered quantities may be inherently noisy to a certain extent, measurement values do not only purely reflect the relations to be investigated. Furthermore, the input data may miss relevant information, e.g., relevant features are not provided or even measured, to model the output data such that regarding the given input data some parts of the output are unpredictable due to the lack of information.

Real world datasets may not be binary in terms of being predictable, meaning that there are some deterministic patterns plus patterns which cannot be inferred from the provided historic data. For example, modeling financial markets solely based on historical data may not be accurate. Therefore, there may not be any machine learning model that is capable of predicting them accurately. Depending on the relative magnitude of these elements, the prediction error can vary even for a successful model. The success of the model can be measured by the machine learning model's ability to extract or learn, respectively, all the available deterministic relations. Consequently, the magnitude of prediction errors alone may not unequivocally signify the model's success or failure.

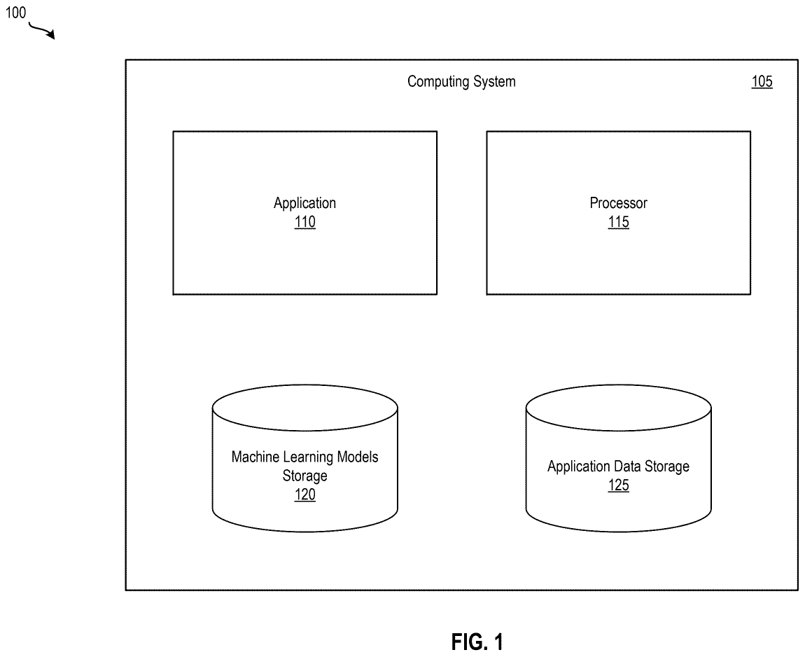

FIG. 1 illustrates a system for evaluating a machine learning model. In various aspects, the system can evaluate an input-output relationship of the machine learning model. As shown, system 100 can include a computing system 105.

As illustrated in FIG. 1, computing system 15 can include an application 110, one or more processors 115, machine learning models storage 120, and application data storage 125. Machine learning models' storage 120 is configured to store machine learning models. In some embodiments, a machine learning model can include a mathematical representation or algorithm that is trained to recognize patterns, make predictions, or categorize data based on input data. The machine learning model can be trained on a dataset, which includes input data and corresponding outputs or labels. The training data helps the model learn the relationships or patterns between the input and output. The machine learning model can adjust its internal parameters, known as weights, to minimize errors in its predictions or classifications. This process is often iterative, involving techniques like gradient descent to improve accuracy over time. Once trained, the machine learning model can make predictions or decisions when given new, unseen data. This process can be called inference.

Machine learning models can include but are not limited to supervised learning models, unsupervised learning models, reinforcement learning models, linear regression models, and neural network models. Supervised Learning Models can be trained on labeled data, where the correct output is provided during training. Unsupervised Learning Models can be trained on unlabeled data, where the model tries to find patterns or groupings in the data. Reinforcement Learning Models can be learned by interacting with an environment and receiving rewards or penalties. Linear Regression Models can predict a continuous output based on input features. Decision Trees Models can split data into branches to make decisions or classifications.

A neural network model is a type of machine learning model inspired by the structure and function of the human brain. A neural network model can consist of interconnected layers of nodes, or “neurons,” that process and transmit information. A neural network can include neurons (nodes), layers, weights and biases, activation function, a loss function, backpropagation, and a learning rate. Each neuron can be a processing unit that receives input, applies a transformation (often a weighted sum followed by a non-linear activation function), and passes the output to the next layer.

The layers can include an input layer, hidden layers, and an output layer. An input layer can be the first layer that receives the initial data (e.g., pixels of an image, features of a dataset). Hidden layers can include intermediate layers between the input and output layers. These hidden layers perform complex computations and extract features from the data. The number of hidden layers and neurons in each layer can vary, making the network deeper or more complex. The output layer can be the final layer that produces the output or prediction. In classification tasks, this might represent probabilities for different classes.

Weights are parameters that adjust the influence of each input on the neuron's output. Biases are additional parameters added to the input, allowing the model to shift the activation function.

Activation Functions can introduce non-linearity into the model, allowing it to learn and represent complex patterns. Common activation functions can include but are not limited to rectified linear unit (ReLU), sigmoid, and tanh.

Forward Propagation can include the process of passing input data through the network, layer by layer, to produce an output.

A loss function can be a function that measures the difference between the predicted output and the actual output (ground truth). Common loss functions include mean squared error or mean absolute error for regression tasks and cross-entropy for classification tasks.

Backpropagation can be an algorithm used to adjust the weights and biases by calculating the gradient of the loss function with respect to each parameter. This can be typically done using a method called gradient descent. A learning rate can be a hyperparameter that controls how much the model's parameters are adjusted during training.

Types of Neural Networks can include but are not limited to Feedforward Neural Networks (FNN), Convolutional Neural Networks (CNN), Recurrent Neural Networks (RNN) and Deep Neural Networks (DNN).

Feedforward Neural Networks (FNN) can include the simplest type where connections between the nodes do not form cycles. Information flows in one direction, from input to output.

Convolutional Neural Networks (CNN) can be specialized for processing structured grid data like images. CNNs can use convolutional layers to automatically and adaptively learn spatial hierarchies of features.

Recurrent Neural Networks (RNN) can be designed for sequential data like time series or natural language. RNNs have connections that form directed cycles, enabling them to maintain a memory of previous inputs.

Deep Neural Networks (DNN) can be Neural networks with many hidden layers. These networks can model complex data with a high level of abstraction.

Neural networks can be used in the following areas: Image and video recognition (e.g., identifying objects in photos), natural language processing (e.g., translating text, sentiment analysis), speech recognition (e.g., converting spoken language into text), and game playing and strategy (e.g., AlphaGo), autonomous vehicles (e.g., object detection and decision-making). Neural networks can be a powerful tool in artificial intelligence (AI) and machine learning, particularly for tasks that involve complex patterns and large amounts of data.

Application data storage 125 stores data generated by, accessed by, associated with, etc., application 110. In some cases, such data is organized according to a machine learning model in machine learning models storage 120.

In some embodiments, machine learning model storage 120 and application data storage 125 are implemented in a single physical storage while, in other embodiments, machine learning model storage 120 and application data storage 125 may be implemented across several physical storages. While FIG. 1 shows machine learning model storage 120 and application data storage 125 as part of computing system 105, one of ordinary skill in the art will appreciate that machine learning model storage 120 and/or application data storage 125 may be external to computing system 105 in some embodiments.

Application 110 is a software application operating on computing system 105 configured to interact with the computing system 105. For example, application 110 may provide machine learning processes using the computing system 105.

Processor 115 handles the processing of the various machine learning models. For instance, the processor 115 may receive data from the application data storage 125 for use with a machine learning model from the machine learning model storage 120. In response, processor 115 executes the machine learning model by accessing application data storage 125 and retrieving the data specified in the machine learning model. Once processor 115 finishes executing the machine learning model process, the processor 115 sends application 110 the retrieved data.

Before any data analysis, machine learning (ML) model training or information extraction from a dataset is the issue of testing to discover if there are such reliable relations between the quantities in the dataset of interest. Such tests deliver valuable insights to evaluate efforts for further analysis, and if reasonable at all. A second aspect after an iteration of data analysis or information extraction, like the training of an ML model, is testing if there is information left to extract or all the reliable information is extracted in terms of deterministic relations between input and output data. If all relations are extracted or learnt, respectively, the deviations between the predictions for the corresponding input data and the target (ground truth) are supposed to be stochastically independent of the input data. Thus, given that input, additional analysis on this input-target relation might not reveal further insights or improve accuracy in terms of extracting more deterministic relations.

Once there is related information our disclosed loss function is supposed to be minimized until all deterministic information are extracted determined by a loss function value below a threshold or the given likeliness of the value is likely enough given the distribution of loss function values under the assumption of independent input and model deviation. The case that there is information to extract can be estimated with our disclosed information theoretic loss function by testing that the just mentioned convergence criteria are not met before model training.

The loss function can employ for instance mutual information or the Chi-Square test of independence or the Pearson correlation to investigate the existence of relations between random variables. In probability theory and information theory, the mutual information of two random variables is a measure of the mutual dependence between the two variables. More specifically, it quantifies the “amount of information” that can be obtained about one random variable by observing the other random variable. The Chi-Square Test of Independence is a statistical test used to determine whether there is a significant association between two categorical variables. It helps to understand if the observed frequencies of categories for one variable differ significantly across the levels of another variable, which would suggest that the variables are not independent of each other. The Pearson correlation, also known as the Pearson correlation coefficient or Pearson's r, is a measure of the linear relationship between two continuous variables. It quantifies the strength and direction of the linear association between the variables, with values ranging from −1 to 1.

One variable could be an input feature, and one variable could be a model deviation value between an output feature to be predicted by a machine learning method and the ground-truth. In the case of several input or output variables, the sum of all pairwise considerations between input and output variables can serve as a measure for information to extract or any other generalization to calculate the information content between input and output variables. This approach may be entirely data-driven and needs no prior knowledge about the data and its distribution.

The framework disclosed herein is not limited to these tests. Other methods that test for information content or stochastic dependence between random variables can be used. The techniques disclosed can demonstrate how to evaluate potential model success as well as to differentiate model inaccuracies into systematic failures and unpredictable parts with respect to the input data. The choice of the measures and their implementations themselves are not limiting.

In some embodiments the ground truth data may be a measurement that is collected directly from the source or observed in real-world conditions, serving as an accurate reference or benchmark for validating or training models, particularly in fields like machine learning, remote sensing, and data analysis. In machine learning, ground truth data is the labeled data used to train and test algorithms, ensuring that the model's predictions are accurate. The term emphasizes the reliability and authenticity of the data as a standard against which other data can be compared or evaluated.

The disclosed approach for measuring the predictability of output based on input variables can be similar to feature selection methods, like the minimize redundancy maximize relevance (mRMR) method, which is based on mutual information. If an input and these deviations take their values totally independent of each other, it means that there is nothing left to learn for a machine learning method, regardless of the loss value which might be high or low depending on the magnitude of the unpredictable component.

For example, consider the prediction of stock prices using time series data. Past stock prices may not always provide a clear indication of future prices due to the complexity of market dynamics and the influence of external factors such as economic events and investor sentiment. Therefore, accurately predicting future stock prices requires understanding and modeling the underlying patterns and dynamics in the time-series data, which may not be directly evident from historical observations alone. Without having a stopping criterion for improvement of the model in such scenarios, one could spend a huge amount of time on learning dynamics which either do not exist (e.g., such as a pure noise) or it is impossible to learn because the given history is sharing no or low information in that regard. Therefore, in such cases, the techniques should know the upper bound of the model's performance to avoid trying to improve it while further improvement is not possible.

Another example is prediction of workloads, e.g., network traffic in datacenters. The traffic patterns in datacenter can be highly divergent, change rapidly, and may vary unpredictably.

Therefore, the disclosed techniques may determine to what extent data-driven approaches can extract deterministic relations from the data. By minimizing the dependence of residual error or in general model deviation from the given input, the disclosed techniques can improve the weights of models and stop the optimization process if a further dependence of model deviation and input is unlikely given the data and the distribution of the loss function under the assumption of independent input and model deviations. This disclosure includes an example implementation of an information theoretic measure given by mutual information and the chi-square test of independence. However, the concept of this disclosure are not limited to these implementations.

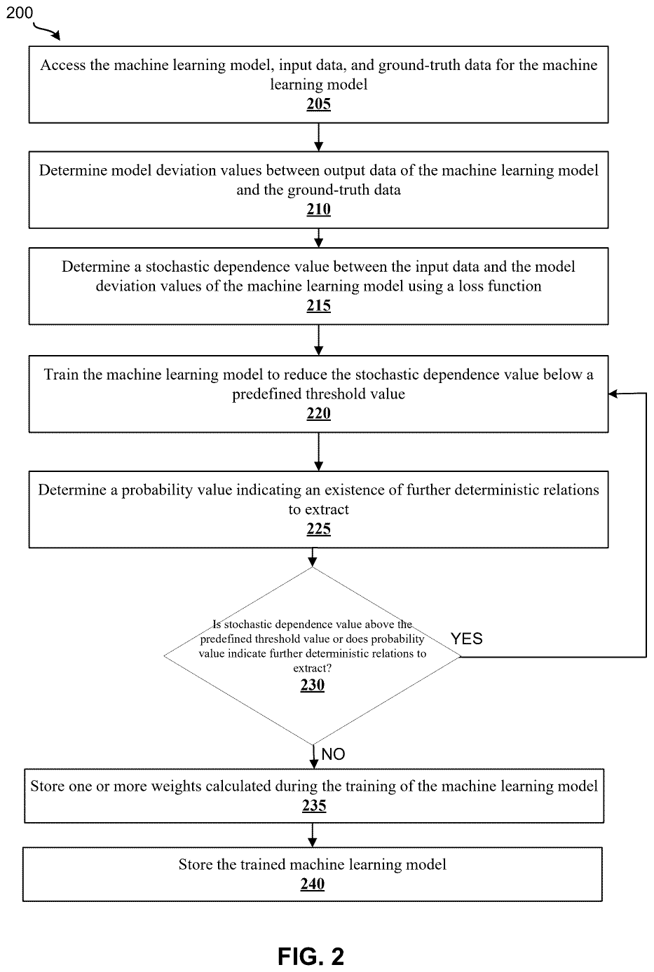

FIG. 2 is a flowchart of an example process 200 for using loss functions to determine stochastic independence between input and output of machine learning models. In some implementations, one or more process blocks of FIG. 2 may be performed by a computing device.

At block 205, process 200 may include accessing the machine learning model, input data, and ground-truth data for the machine learning model. For example, computing device may access the machine learning model, the input data, and the ground-truth data for the machine learning model by applying the information theoretic measure to the input and the ground truth data to measure the corresponding dependence. The machine learning model can be stored in a memory on the computing device. Similarly, the input data and ground-truth data for the machine learning model can be stored in a memory. The memory can include a storage system (e.g., a cloud-based storage system), a virtual memory, a physical drive, a portable drive, a memory stick, etc.

At block 210, process 200 may include determining model deviation values between output data of the machine learning model and output ground-truth data. In various embodiments, one or more model deviation values may be calculated. The output data can be model output data from the machine learning model. For example, computing device may determine model deviation values between output data of the machine learning model and the ground-truth data, as described above.

In various embodiments, the model deviation values can be calculated as a difference between the output data and the ground-truth data for ordinal data types. In various embodiments, the ordinal data types may include continuous and categorical data that has a ranking. Ordinal data types can include data such as but not limited to network traffic data, stock price data, and temperature data. In an example, if the input value is historical stock prices and the output is a predicted stock price, the model deviation value can be the difference between the predicted stock price and an actual stock price at the predicted time.

In various embodiments, the model deviation values can be calculated using a predicted probability distribution over different classes and a ground-truth distribution for nominal data types. In some embodiments the difference of the distribution per class forms a random variable. Consequently, the nominal case can be traced back to a multidimensional ordinal case. In various embodiments, nominal data may include variables used to categorize data without any quantitative value. Examples of nominal data can include but are not limited to different classes of images in any image classification task, different classes of time series in any time-series classification tasks, different classes of sound in any sound classification task, and credit worthiness data. For example, if there is an image classifier that can be used to determine a type of fruit from various images, the type of fruit can be considered a class. The model deviation from the ground truth per sample can be the difference between the probability distribution over the classes of the ground truth and the predicted distribution. The ground truth distribution can look like a 1 for the correct class and a 0 else. For nominal data it is a multidimensional residual problem because for each class the model can have a one-dimensional difference between the output data and the ground-truth data. The model deviation values can then be the probability for each class minus the predicted probability for each class. In one example, the ground truth can be a value of zero and perhaps the machine learning model achieves a model deviation of 0.2.

At block 215, process 200 may include determining a stochastic dependence value between the input data and the model deviation values of the machine learning model using a loss function. For example, a computing device may determine a stochastic dependence value between the input data and the model deviation values of the machine learning model using a loss function, as described above.

Stochastic independence, also known as statistical independence, is a concept in probability theory that refers to the relationship between two or more random variables. Two random variables are said to be stochastically independent if the knowledge about the value of one variable does not provide information about the value of the second variable.

In various embodiments, the introduced loss function decreases when the model deviation value and input become more independent. However, the loss function value may not reach zero often in real practical settings which is due to noise in the data, spurious correlations, quantization, floating point representations or any other factor that deviates between the theoretical and practical settings.

Loss functions that measure a stochastic independence can be used in various fields like statistics, machine learning, and information theory. These functions help quantify the degree to which two or more random variables are independent. Some common loss functions and techniques used to assess stochastic independence include Chi Square, mutual information (MI), Maximum Mean Discrepancy (MMD), distance correlation, adversarial loss functions, Hilbert-Schmidt Independence Criterion, and Cross-Entropy. Gradient based methods can be applied to minimize an approximation of mutual information or Chi Square. The techniques are not limited to the specific type of loss function used and any type of loss function that measures stochastic independence may alternatively be used.

In various embodiments, the residual data and input data can be the data that should be passed to such a loss function. A customized, traditional loss function for machine learning training can be defined as follows. Given a standard vector norm-based loss function C (y, y_{g}) considering only the tuple (y, y_{g}), where y is the model output, and y_{g} is the ground-truth data. The proposed information theoretic based loss function C (y, y_{g}, x) considers a triple wherein in addition to y and y_{g}, the techniques can consider where x, which is the input data, since instead of only punishing the model deviation (as normally being done), it is desirable to punish the model deviation when it is (at least partially) predictable based on the input x. Furthermore, for an information theoretical loss function, a probability for the observed loss function value under the assumption of the input data being independent of the model deviations can be optionally provided.

In one embodiment, the mutual information (MI) based loss function C (y, y_{g}, x) can be defined as a Python function to include into the PyTorch framework. A residual value can be defined by the equation: r(y)=y−y_{g}, which is a specific case of deviation for ordinal data.

In one embodiment, MI can be estimated via specific frameworks, like other ML algorithms, called MI estimator. In each epoch of model training, the machine learning model can retain or finetune the used MI estimator model E (r, x)→MI, where r is the model deviation, like the residual or the difference of probability distributions for a given x. At various points in the training, the techniques can freeze the weights of E and compute the gradient of this loss with respect to the weights of the prediction network. If the MI estimator E (r, x) value is small enough the input and residual data can be considered to be decoupled meaning that the two values are stochastically independent from each other.

In one embodiment, one can compute a probability distribution of the data based on the samples by making the histogram of the joint and marginals which allows to compute mutual information. However, the histogram-based method often suffers from non-differentiability. Therefore, it may be possible to end up with a nondifferentiable metric which cannot be optimized using gradient based method and therefore may not be considered as a suitable loss function.

In mutual information (MI) or chi-square-based loss functions, especially when dealing with continuous variables, the variables are often discretized into bins to calculate the probability distributions. Each bin represents a range of variable values, and the count or density of data points within each bin can be used to estimate probabilities. This binning with its boundaries may lead to non-differentiability issues of an information theoretical loss function.

To mitigate the issue non-differentiability smoothing techniques, differentiable binning, and adaptive binning techniques can be applied.

Kernel density estimation (KDE) or other smoothing techniques can be used to estimate probability distributions without relying strictly on hard bin boundaries.

Differentiable binning can use soft binning techniques that allow data points to contribute to multiple bins in a weighted manner, which may provide the gradients.

During adaptive binning techniques the bin sizes can be dynamically adjusted based on data distribution to reduce the impact of boundary crossings.

In various embodiments, MI approximation can be used with a smoothed discretization scheme. To avoid concentrating the whole mass of a point, where a residual r (y)=y−y_{g} is located into 0-dimensional location, which causes non-differentiability when crossing bin boundaries, the point is smoothed out using some kernel, which may be of compact/bounded support. Note that y_{g} is the ground truth value. The following explanation is done for a one-dimensional variable y, but the procedure holds true for the general case where y is a vector. In particular, this explanation includes the nominal case that can be traced back to a multi-dimensional ordinal case.

Such a kernel function may be defined as:

$$g : ℝ \to ℝ , t \to g ( t ; r ( y ) , σ ) ,$$

like a truncated Gaussian kernel that has the mass 1 integrated over the compact support where σ is a vector of fixed parameters of that distribution function. The whole mass function integrating all residuals is given by the mixture of such kernels each centered at r(yₖ):

$$f : ℝ \to ℝ , t \to f ( t , {y}^{\to } ) := {\sum }_{k = 1}^{N} {g}_{k} ( t ; r ( {y}_{k} ) , σ )$$

where k enumerates the number of residuals and N is the number of samples in the dataset (equals the number of samples in the data set) and \vec{ }y is a vector that includes all the outputs of the model, which is only one in this case without restricting the generality. The corresponding marginal probability of xⱼ is given by the following:

$$P ( {x}_{j} = {z}_{{x}_{j}}^{l} )$$

where xⱼ (j runs through feature number) equals

$${z}_{{x}_{j}}^{l}$$

means that the value of xⱼ to within the bin l (l runs over the bin number). The marginal probability for y is given by the following equation:

$$P ( {a}_{i} \leq y \leq {a}_{i + 1} = \frac{1}{N} {\int }_{{a}_{i}}^{{a}_{i + 1}} f ( t , y ) dt$$

for each i∈{1, . . . , M} where

$$M = \frac{1}{γ}$$

and γ>0 is the fraction of mass per bin in the equi-mass discretized range (co-domain) of y. The optimization target is given by the following equations:

$${min}_{y , ω , a} C ( y , {y}_{g} , x )$$

$$s . t . y = F ( w , x )$$

$$P ( {a}_{i} \leq y \leq {a}_{i + 1} ) = γ or all i$$

$${a}_{i} < {a}_{i + 1} for all i$$

where F are the machine learning model equalities (the model), x is a vector over all input features and a is the vector containing the boundaries of the bins. Alternatively, if one would like to turn the hard-constrained optimization problem into soft-constrained, e.g., because Pytorch does not allow an easy extension of the machine learning optimization algorithm with further constraints, then one might use the following formulation given by the following equation:

$${min}_{y , ω , a} C ( y , {y}_{g} , x ) + α {( y - F ( w , x ) )}^{2} + {α}_{2} {\sum }_{i} ( P {( {a}_{i} \leq y \leq {a}_{i + 1} )}^{2} + {{α}_{3} ( max ( {a}_{i} - {a}_{i + 1} , 0 ) )}^{2}$$

where α₁, α₂, α₃>0. If necessary, e.g., because there is aᵢ=aᵢ₊₁ for one i, then include a minimal bin width δ>0 (aᵢ₊₁−aᵢ>δ leading to max(δ+aᵢ₊₁,0)).

At block 220, process 200 may include training the machine learning model to reduce the stochastic dependence value below a predefined threshold value. For example, a computing device may train the machine learning model to reduce the stochastic dependence value below a predefined threshold value, as described above.

Training a model to reduce stochastic dependence between two or more random variables modeling input and model deviation means encouraging the model to capture dependencies between input and ground-truth output.

Another approach can be to train a discriminator to distinguish between joint samples (X, Y) and independent samples (X, Y′) (where Y′ is sampled independently from Y).

The model is trained to make it hard for the discriminator to tell apart the joint and independent samples, effectively reducing independence.

The Nonlinear Canonical Correlation Analysis (CCA) technique can be used to find representations that are maximally correlated in a nonlinear manner.

Train two neural networks to produce representations of two views such that their correlation is maximized. This ensures that the learned representations capture the shared information, reducing independence.

Variational Inference Approaches can be used to model dependencies between variables by learning a joint distribution.

Variational Autoencoders (VAEs) can be used to model the joint distribution of the variables of interest. By optimizing the evidence lower bound (ELBO), the model learns to capture dependencies in a latent space.

At block 225, process 200 may include determining a probability value. The probability value can indicate an existence of further deterministic relations to extract. The probability value can indicate further change of the stochastic dependence value using a distribution of loss function values. In various embodiments, the probability value can indicate an update of one or more weights resulting in significantly lowering the stochastic dependence value. For example, the computing device may determine a probability value indicating further change of the stochastic dependence value u using a distribution of loss function values, as described above. The probability value can be used as a stopping criterion for the training of the model.

The probability value can determine the likelihood that further training will change the stochastic dependence value or not (or if further training is necessary). For example, in some cases certain inaccuracies such as spurious correlation, quantization noise, measurement error or some other factor in the data might prevent the stochastic dependence value from reaching zero. If the probability value is greater, less or equal to certain values depending on how the probability value is defined, the probability value can indicate that it is unlikely that the stochastic dependence value significantly decreases. In this case, the training will be complete.

At block 230, if the stochastic dependence value is above the predefined threshold value, process 200 may include training the machine learning model to reduce the stochastic dependence value below the predefined threshold value. For example, computing device may determine if the stochastic dependence value is above the predefined threshold value and if so, continue training the machine learning model to reduce the stochastic dependence value below the predefined threshold value, as described above.

At block 230, process 200 may determine if the stochastic dependence value is at or below the predefined threshold value or the probability value is greater than, less than, or equal to a predefined probability value, depending on how it is defined. At this point, the training of the model can be considered to be complete. The predefined probability value is a measurement of how likely the current stochastic deviation value is assuming the independence of the input and model deviation will be at or below a predetermined threshold. One method to compute such a distribution can be a permutation test if no theoretical distribution is available. Afterwards, this probability value, depending on how it is defined, can determine if there are still deterministic relations in the data left possibly because such a value is too unlikely under the independence assumption. In such cases that there are some deterministic relations that have not been learned in the data by the model, training should be continued. Therefore, the predefined value of the loss function can be enriched by a likeliness value. Often in practical situations, the loss function value approaches but never reaches zero even if the input and model deviation are totally independent of each other. This can be due to some errors such as quantization noise, spurious correlation, or other inaccuracies in the data. As this is the case, the techniques need a practical stopping criteria for training the model. Therefore, the probability value can be used to account for spurious correlations and other practical issues that are in the data that prevent the loss function from becoming completely zero.

The probability value for the loss function value does not come from the loss function itself but from the stochastic framework around it. During each epoch of training a loss function value can be calculated (e.g., 0.1, 0.2, 0.3 etc.). A probability value can be calculated for each loss function value using the distribution of loss function values to calculate the likeliness of the currently observed loss function value. This probability value can then be used to define a stopping criterion. Possible ways to find the likeliness of the loss function values are a theoretical distribution or a permutation method shuffling the association of input and model deviation values.

At block 235, process 200 may include storing one or more weights calculated during the training of the machine learning model. For example, the computing device may store one or more weights used to train the machine learning model, as described above. The weights can be stored in a storage system, i.e., the cloud storage system.

At block 240, process 200 may include storing the trained machine learning model. For example, a computing device may store the trained machine learning model.

Process 200 may include additional implementations, such as any single implementation or any combination of implementations described below and/or in connection with one or more other processes described elsewhere herein.

In various embodiments, process 200 may include smoothing the loss function with respect to the output data. In various embodiments, process 200 may include testing the machine learning model using the one or more weights and the input data.

Although FIG. 2 shows example blocks of process 200, in some implementations, process 200 may include additional blocks, fewer blocks, different blocks, or differently arranged blocks than those depicted in FIG. 2. Additionally, or alternatively, two or more of the blocks of process 200 may be performed in parallel.

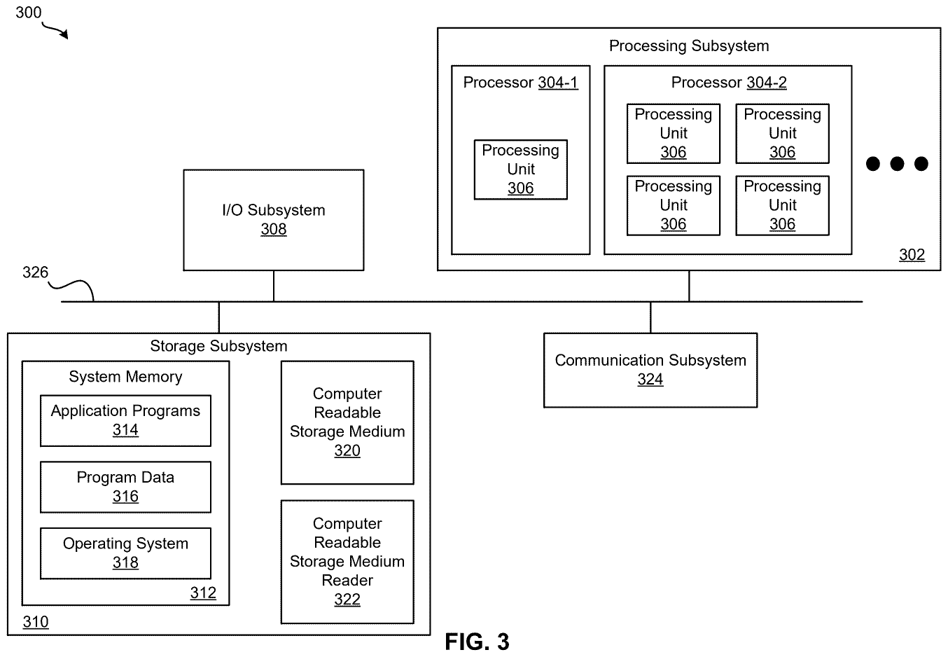

FIG. 3 illustrates an exemplary computer system 300 for implementing various embodiments described above. For example, computer system 300 may be used to implement computing system 105. Computer system 300 may be a desktop computer, a laptop, a server computer, or any other type of computer system or combination thereof. Some or all elements of the application 110, processor 115, application 130, or combinations thereof can be included or implemented in computer system 300. In addition, computer system 300 can implement many of the operations, methods, and/or processes described above (e.g., process 200). As shown in FIG. 3, computer system 300 includes processing subsystem 302, which communicates, via bus subsystem 326, with input/output (I/O) subsystem 308, storage subsystem 310 and communication subsystem 324.

Bus subsystem 326 is configured to facilitate communication among the various components and subsystems of computer system 300. While bus subsystem 326 is illustrated in FIG. 3 as a single bus, one of ordinary skill in the art will understand that bus subsystem 326 may be implemented as multiple buses. Bus subsystem 326 may be any of several types of bus structures (e.g., a memory bus or memory controller, a peripheral bus, a local bus, etc.) using any of a variety of bus architectures. Examples of bus architectures may include an Industry Standard Architecture (ISA) bus, a Micro Channel Architecture (MCA) bus, an Extended ISA (EISA) bus, a Video Electronics Standards Association (VESA) local bus, a Peripheral Component Interconnect (PCI) bus, a Universal Serial Bus (USB), etc.

Processing subsystem 302, which can be implemented as one or more integrated circuits (e.g., a conventional microprocessor or microcontroller), controls the operation of computer system 300. Processing subsystem 302 may include one or more processors 304. Each processor 304 may include one processing unit 306 (e.g., a single core processor such as processor 304-1) or several processing units 306 (e.g., a multicore processor such as processor 304-2). In some embodiments, processors 304 of processing subsystem 302 may be implemented as independent processors while, in other embodiments, processors 304 of processing subsystem 302 may be implemented as multiple processors integrate into a single chip or multiple chips. Still, in some embodiments, processors 304 of processing subsystem 302 may be implemented as a combination of independent processors and multiple processors integrated into a single chip or multiple chips.

In some embodiments, processing subsystem 302 can execute a variety of programs or processes in response to program code and can maintain multiple concurrently executing programs or processes. At any given time, some or all of the program code to be executed can reside in processing subsystem 302 and/or in storage subsystem 310. Through suitable programming, processing subsystem 302 can provide various functionalities, such as the functionalities described above by reference to process 200.

I/O subsystem 308 may include any number of user interface input devices and/or user interface output devices. User interface input devices may include a keyboard, pointing devices (e.g., a mouse, a trackball, etc.), a touchpad, a touch screen incorporated into a display, a scroll wheel, a click wheel, a dial, a button, a switch, a keypad, audio input devices with voice recognition systems, microphones, image/video capture devices (e.g., webcams, image scanners, barcode readers, etc.), motion sensing devices, gesture recognition devices, eye gesture (e.g., blinking) recognition devices, biometric input devices, and/or any other types of input devices.

User interface output devices may include visual output devices (e.g., a display subsystem, indicator lights, etc.), audio output devices (e.g., speakers, headphones, etc.), etc. Examples of a display subsystem may include a cathode ray tube (CRT), a flat-panel device (e.g., a liquid crystal display (LCD), a plasma display, etc.), a projection device, a touch screen, and/or any other types of devices and mechanisms for outputting information from computer system 300 to a user or another device (e.g., a printer).

As illustrated in FIG. 3, storage subsystem 310 includes system memory 312, computer-readable storage medium 320, and computer-readable storage medium reader 322. System memory 312 may be configured to store software in the form of program instructions that are loadable and executable by processing subsystem 302 as well as data generated during the execution of program instructions. In some embodiments, system memory 312 may include volatile memory (e.g., random access memory (RAM)) and/or non-volatile memory (e.g., read-only memory (ROM), programmable read-only memory (PROM), erasable programmable read-only memory (EPROM), electrically erasable programmable read-only memory (EEPROM), flash memory, etc.). System memory 312 may include different types of memory, such as static random-access memory (SRAM) and/or dynamic random-access memory (DRAM). System memory 312 may include a basic input/output system (BIOS), in some embodiments, which is configured to store basic routines to facilitate transferring information between elements within computer system 300 (e.g., during start-up). Such a BIOS may be stored in ROM (e.g., a ROM chip), flash memory, or any other type of memory that may be configured to store the BIOS.

As shown in FIG. 3, system memory 312 includes application programs 314 (e.g., application 130), program data 316, and operating system (OS) 318. OS 318 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple IOS, Windows Phone, Windows Mobile, Android, BlackBerry OS, Blackberry 10, and Palm OS, WebOS operating systems.

Computer-readable storage medium 320 may be a non-transitory computer-readable medium configured to store software (e.g., programs, code modules, data constructs, instructions, etc.). Many of the components (e.g., the application 110, the machine learning model storage 120, application data storage 125, and processor 115) and/or processes (e.g., process 200) described above may be implemented as software that when executed by a processor or processing unit (e.g., a processor or processing unit of processing subsystem 302) performs the operations of such components and/or processes. Storage subsystem 310 may also store data used for, or generated during, the execution of the software.

Storage subsystem 310 may also include computer-readable storage medium reader 322 that is configured to communicate with computer-readable storage medium 320. Together and optionally, in combination with system memory 312, computer-readable storage medium 320 may comprehensively represent remote, local, fixed, and/or removable storage devices plus storage media for temporarily and/or more permanently containing, storing, transmitting, and retrieving computer-readable information.

Computer-readable storage medium 320 may be any appropriate media known or used in the art, including storage media such as volatile, non-volatile, removable, non-removable media implemented in any method or technology for storage and/or transmission of information. Examples of such storage media includes RAM, ROM, EEPROM, flash memory or other memory technology, compact disc read-only memory (CD-ROM), digital versatile disk (DVD), Blu-ray Disc (BD), magnetic cassettes, magnetic tape, magnetic disk storage (e.g., hard disk drives), Zip drives, solid-state drives (SSDs), flash memory card (e.g., secure digital (SD) cards, CompactFlash cards, etc.), USB flash drives, or any other type of computer-readable storage media or device.

Communication subsystem 324 serves as an interface for receiving data from, and transmitting data to, other devices, computer systems, and networks. For example, communication subsystem 324 may allow computer system 300 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication subsystem 324 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication subsystem 324 may provide components configured for wired communication (e.g., Ethernet) in addition to or instead of components configured for wireless communication.

One of ordinary skill in the art will realize that the architecture shown in FIG. 3 is only an example architecture of computer system 300, and that computer system 300 may have additional or fewer components than shown, or a different configuration of components. The various components shown in FIG. 3 may be implemented in hardware, software, firmware, or any combination thereof, including one or more signal processing and/or application specific integrated circuits.

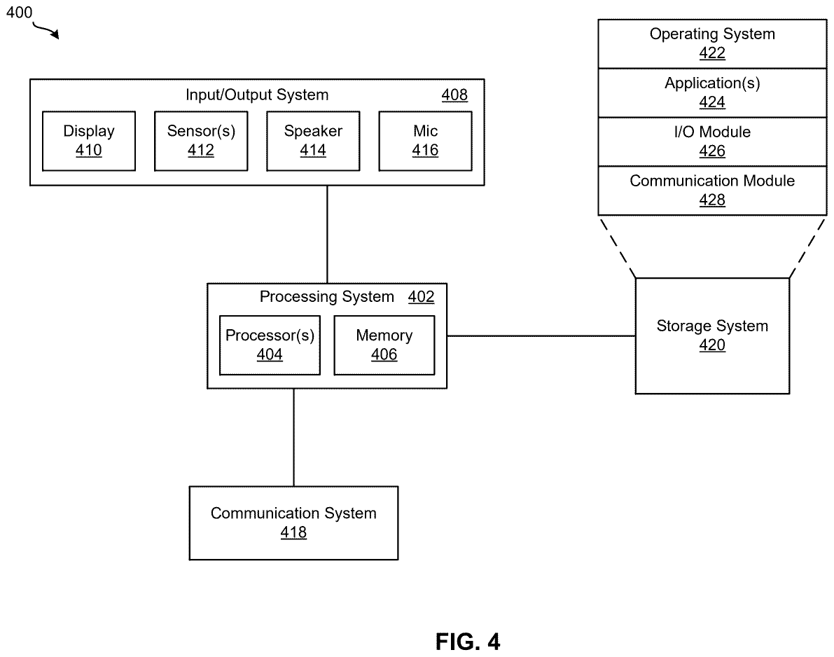

FIG. 4 illustrates an exemplary computing device 400 for implementing various embodiments described above. Computing device 400 may be a cellphone, a smartphone, a wearable device, an activity tracker or manager, a tablet, a personal digital assistant (PDA), a media player, or any other type of mobile computing device or combination thereof. Some or all elements of the application 110, processor 115, machine learning models storage, and application data storage 125, or combinations thereof can be included or implemented in computing device 400. In addition, computing device 400 can implement many of the operations, methods, and/or processes described above (e.g., process 200). As shown in FIG. 4, computing device 400 includes processing system 402, input/output (I/O) system 408, communication system 418, and storage system 420. These components may be coupled by one or more communication buses or signal lines.

Processing system 402, which can be implemented as one or more integrated circuits (e.g., a conventional microprocessor or microcontroller), controls the operation of computing device 400. As shown, processing system 402 includes one or more processors 404 and memory 406. Processors 404 are configured to run or execute various software and/or sets of instructions stored in memory 406 to perform various functions for computing device 400 and to process data.

Each processor of processors 404 may include one processing unit (e.g., a single core processor) or several processing units (e.g., a multicore processor). In some embodiments, processors 404 of processing system 402 may be implemented as independent processors while, in other embodiments, processors 404 of processing system 402 may be implemented as multiple processors integrated into a single chip. Still, in some embodiments, processors 404 of processing system 402 may be implemented as a combination of independent processors and multiple processors integrated into a single chip.

Memory 406 may be configured to receive and store software (e.g., operating system 422, applications 424, I/O module 426, communication module 428, etc. from storage system 420) in the form of program instructions that are loadable and executable by processors 404 as well as data generated during the execution of program instructions. In some embodiments, memory 406 may include volatile memory (e.g., random access memory (RAM)), non-volatile memory (e.g., read-only memory (ROM), programmable read-only memory (PROM), erasable programmable read-only memory (EPROM), electrically erasable programmable read-only memory (EEPROM), flash memory, etc.), or a combination thereof.

I/O system 408 is responsible for receiving input through various components and providing output through various components. As shown for this example, I/O system 408 includes display 410, one or more sensors 412, speaker 414, and microphone 416. Display 410 is configured to output visual information (e.g., a graphical user interface (GUI) generated and/or rendered by processors 404). In some embodiments, display 410 is a touch screen that is configured to also receive touch-based input. Display 410 may be implemented using liquid crystal display (LCD) technology, light-emitting diode (LED) technology, organic LED (OLED) technology, organic electro luminescence (OEL) technology, or any other type of display technologies. Sensors 412 may include any number of different types of sensors for measuring a physical quantity (e.g., temperature, force, pressure, acceleration, orientation, light, radiation, etc.). Speaker 414 is configured to output audio information and microphone 416 is configured to receive audio input. One of ordinary skill in the art will appreciate that I/O system 408 may include any number of additional, fewer, and/or different components. For instance, I/O system 408 may include a keypad or keyboard for receiving input, a port for transmitting data, receiving data and/or power, and/or communicating with another device or component, an image capture component for capturing photos and/or videos, etc.

Communication system 418 serves as an interface for receiving data from, and transmitting data to, other devices, computer systems, and networks. For example, communication system 418 may allow computing device 400 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication system 418 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication system 418 may provide components configured for wired communication (e.g., Ethernet) in addition to or instead of components configured for wireless communication.

Storage system 420 handles the storage and management of data for computing device 400. Storage system 420 may be implemented by one or more non-transitory machine-readable mediums that are configured to store software (e.g., programs, code modules, data constructs, instructions, etc.) and store data used for, or generated during, the execution of the software. Many of the components (e.g., application 110 and processor 115) and/or processes (e.g., process 200) described above may be implemented as software that when executed by a processor or processing unit (e.g., processors 404 of processing system 402) performs the operations of such components and/or processes.

In this example, storage system 420 includes operating system 422, one or more applications 424, I/O module 426, and communication module 428. Operating system 422 includes various procedures, sets of instructions, software components and/or drivers for controlling and managing general system tasks (e.g., memory management, storage device control, power management, etc.) and facilitates communication between various hardware and software components. Operating system 422 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple IOS, Windows Phone, Windows Mobile, Android, BlackBerry OS, Blackberry 10, and Palm OS, WebOS operating systems.

Applications 424 can include any number of different applications installed on computing device 400. Examples of such applications may include a browser application, an address book application, a contact list application, an email application, an instant messaging application, a word processing application, JAVA-enabled applications, an encryption application, a digital rights management application, a voice recognition application, location determination application, a mapping application, a music player application, etc.

I/O module 426 manages information received via input components (e.g., display 410, sensors 412, and microphone 416) and information to be output via output components (e.g., display 410 and speaker 414). Communication module 428 facilitates communication with other devices via communication system 418 and includes various software components for handling data received from communication system 418.

One of ordinary skill in the art will realize that the architecture shown in FIG. 4 is only an example architecture of computing device 400, and that computing device 400 may have additional or fewer components than shown, or a different configuration of components. The various components shown in FIG. 4 may be implemented in hardware, software, firmware, or any combination thereof, including one or more signal processing and/or application specific integrated circuits.

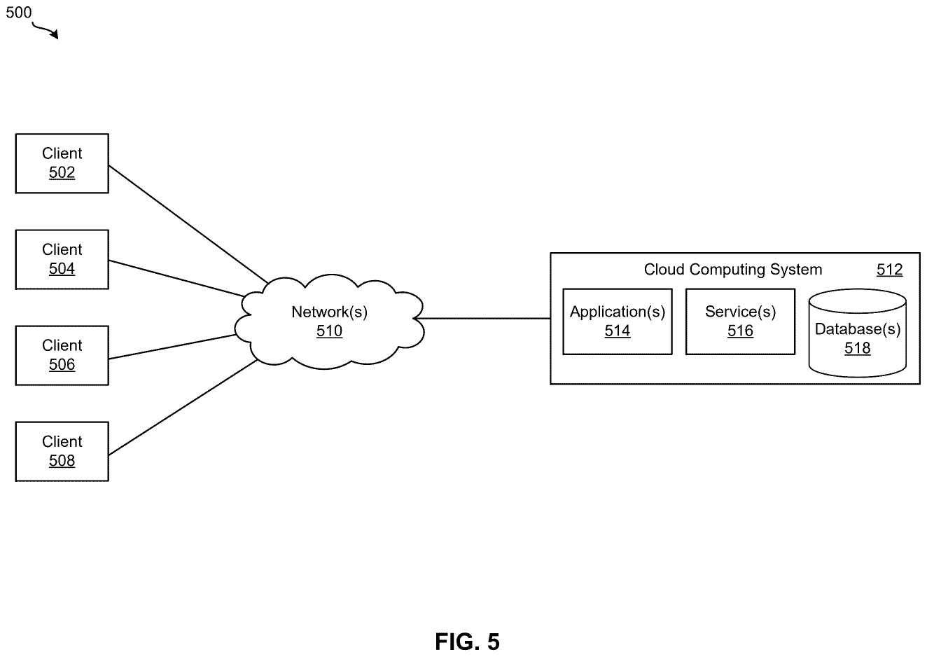

FIG. 5 illustrates an exemplary system 500 for implementing various embodiments described above. For example, any client devices 502-508 may be used to implement the computing system 105 and cloud computing system 512 may be used to implement computing system 105. As shown, system 500 includes client devices 502-508, one or more networks 510, and cloud computing system 512. Cloud computing system 512 is configured to provide resources and data to client devices 502-508 via networks 510. In some embodiments, cloud computing system 512 provides resources to any number of different users (e.g., customers, tenants, organizations, etc.). Cloud computing system 512 may be implemented by one or more computer systems (e.g., servers), virtual machines operating on a computer system, or a combination thereof.

As shown, cloud computing system 512 includes one or more applications 514, one or more services 516, and one or more databases 518. Cloud computing system 512 may provide applications 514, services 516, and databases 518 to any number of different customers in a self-service, subscription-based, elastically scalable, reliable, highly available, and secure manner.

In some embodiments, cloud computing system 512 may be adapted to automatically provision, manage, and track a customer's subscriptions to services offered by cloud computing system 512. Cloud computing system 512 may provide cloud services via different deployment models. For example, cloud services may be provided under a public cloud model in which cloud computing system 512 is owned by an organization selling cloud services and the cloud services are made available to the general public or different industry enterprises. As another example, cloud services may be provided under a private cloud model in which cloud computing system 512 is operated solely for a single organization and may provide cloud services for one or more entities within the organization. The cloud services may also be provided under a community cloud model in which cloud computing system 512 and the cloud services provided by cloud computing system 512 are shared by several organizations in a related community. The cloud services may also be provided under a hybrid cloud model, which is a combination of two or more of the aforementioned different models.

In some instances, any one of applications 514, services 516, and databases 518 made available to client devices 502-508 via networks 510 from cloud computing system 512 is referred to as a “cloud service.” Typically, servers and systems that make up cloud computing system 512 are different from the on-premises servers and systems of a customer. For example, cloud computing system 512 may host an application and a user of one of client devices 502-508 may order and use the application via networks 510.

Applications 514 may include software applications that are configured to execute on cloud computing system 512 (e.g., a computer system or a virtual machine operating on a computer system) and be accessed, controlled, managed, etc. via client devices 502-508. In some embodiments, applications 514 may include server applications and/or mid-tier applications (e.g., HTTP (hypertext transfer protocol) server applications, FTP (file transfer protocol) server applications, CGI (common gateway interface) server applications, JAVA server applications, etc.). Services 516 are software components, modules, application, etc. that are configured to execute on cloud computing system 512 and provide functionalities to client devices 502-508 via networks 510. Services 516 may be web-based services or on-demand cloud services.

Databases 518 are configured to store and/or manage data that is accessed by applications 514, services 516, and/or client devices 502-508. For instance, machine learning model storage 120 and application data storage 125 may be stored in databases 518. Databases 518 may reside on a non-transitory storage medium local to (and/or resident in) cloud computing system 512, in a storage-area network (SAN), on a non-transitory storage medium local located remotely from cloud computing system 512. In some embodiments, databases 518 may include relational databases that are managed by a relational database management system (RDBMS). Databases 518 may be a column-oriented databases, row-oriented databases, or a combination thereof. In some embodiments, some or all of databases 518 are in-memory databases. That is, in some such embodiments, data for databases 518 are stored and managed in memory (e.g., random access memory (RAM)).

Client devices 502-508 are configured to execute and operate a client application (e.g., a web browser, a proprietary client application, etc.) that communicates with applications 514, services 516, and/or databases 518 via networks 510. This way, client devices 502-508 may access the various functionalities provided by applications 514, services 516, and databases 518 while applications 514, services 516, and databases 518 are operating (e.g., hosted) on cloud computing system 512. Client devices 502-508 may be computer system 500 or computing system 105, as described above by reference to FIGS. 4 and 5, respectively. Although system 500 is shown with four client devices, any number of client devices may be supported.

Networks 510 may be any type of network configured to facilitate data communications among client devices 502-508 and cloud computing system 512 using any of a variety of network protocols. Networks 510 may be a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.

The above description illustrates various embodiments of the present disclosure along with examples of how aspects of the present disclosure may be implemented. The above examples and embodiments should not be deemed to be the only embodiments and are presented to illustrate the flexibility and advantages of various embodiments of the present disclosure as defined by the following claims. Based on the above disclosure and the following claims, other arrangements, embodiments, implementations, and equivalents will be evident to those skilled in the art and may be employed without departing from the spirit and scope of the present disclosure as defined by the claims.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or” unless explicitly stated otherwise (e.g., if used in combination with “either” or “only one of”).

What is claimed is:

1. A computer implemented method for evaluating an input-output relationship of a machine learning model, the computer implemented method comprising:
accessing the machine learning model, input data, and ground-truth data for the machine learning model;
determining model deviation values between output data of the machine learning model and the ground-truth data;
determining a stochastic dependence value between the input data and the model deviation values of the machine learning model using a loss function;
training the machine learning model to reduce the stochastic dependence value below a predefined threshold value;
determining a probability value indicating an existence of further deterministic relations to extract;
if the stochastic dependence value is above the predefined threshold value:
continue training the machine learning model to reduce the stochastic dependence value below the predefined threshold value;
if the stochastic dependence value is at or below the predefined threshold value or the probability value is greater than, less than, or equal to a predefined probability value:
storing one or more weights calculated during the training of the machine learning model; and
storing the trained machine learning model.

2. The computer implemented method for evaluating the input-output relationship of the machine learning model of claim 1, wherein the model deviation values are calculated as a difference between the output data and the ground-truth data for ordinal data types.

3. The computer implemented method for evaluating the input-output relationship of the machine learning model of claim 2, wherein ordinal data types comprise categorical and continuous data that has a ranking.

4. The computer implemented method for evaluating the input-output relationship of the machine learning model of claim 1, wherein the model deviation values are calculated using a predicted probability distribution over different classes and a ground-truth distribution for nominal data types.

5. The computer implemented method for evaluating the input-output relationship of the machine learning model of claim 1, wherein nominal data comprises variables used to categorize data without any ranking.

6. The computer implemented method for evaluating the input-output relationship of the machine learning model of claim 1, further comprising smoothing the loss function with regard to the output data.

7. The computer implemented method for evaluating the input-output relationship of the machine learning model of claim 1, further comprising testing the machine learning model using the one or more weights and the input data.

8. A non-transitory computer-readable medium storing a set of instructions for evaluating an input-output relationship of a machine learning model, the set of instructions comprising:
one or more instructions that, when executed by one or more processors of a device, cause the device to:
access the machine learning model, input data, and ground-truth data for the machine learning model;
determine model deviation values between output data of the machine learning model and the ground-truth data;
determine a stochastic dependence value between the input data and the model deviation values of the machine learning model using a loss function;
train the machine learning model to reduce the stochastic dependence value below a predefined threshold value;
determine a probability value indicating an existence of further deterministic relations to extract;
if the stochastic dependence value is above the predefined threshold value:
continue training the machine learning model to reduce the stochastic dependence value below the predefined threshold value;
if the stochastic dependence value is at or below the predefined threshold value or the probability value is greater than, less than, or equal to a predefined probability value:
store one or more weights calculated during the training of the machine learning model; and
store the trained machine learning model.

9. The non-transitory computer-readable medium of claim 8, wherein the model deviation values are calculated as a difference between the output data and the ground-truth data for ordinal data types.

10. The non-transitory computer-readable medium of claim 9, wherein the ordinal data types comprise categorical and continuous data that has a ranking.

11. The non-transitory computer-readable medium of claim 8, wherein the model deviation values are calculated using a predicted probability distribution over different classes and a ground-truth distribution for nominal data types.

12. The non-transitory computer-readable medium of claim 8, wherein nominal data comprises variables used to categorize data without any ranking.

13. The non-transitory computer-readable medium of claim 8, wherein the one or more instructions further cause the device to smooth the loss function with regard to the output data.

14. The non-transitory computer-readable medium of claim 8, wherein the one or more instructions further cause the device to test the machine learning model using the one or more weights and the input data.

15. A system for evaluating an input-output relationship of a machine learning model comprising:
one or more processors configured to:
access the machine learning model, input data, and ground-truth data for the machine learning model;
determine model deviation values between output data of the machine learning model and the ground-truth data;
determine a stochastic dependence value between the input data and the model deviation values of the machine learning model using a loss function;
train the machine learning model to reduce the stochastic dependence value below a predefined threshold value;
determine a probability value indicating an existence of further deterministic relations to extract;
if the stochastic dependence value is above the predefined threshold value:
continue training the machine learning model to reduce the stochastic dependence value below the predefined threshold value;
if the stochastic dependence value is at or below the predefined threshold value or the probability value is greater than, less than, or equal to a predefined probability value:
store one or more weights calculated during the training of the machine learning model; and
store the trained machine learning model.

16. The system of claim 15, wherein the model deviation values are calculated as a difference between the output data and the ground-truth data for ordinal data types.

17. The system of claim 16, wherein the ordinal data types comprise categorical and continuous data that has a ranking.

18. The system of claim 15, wherein the model deviation values are calculated using a predicted probability distribution over different classes and a ground-truth distribution for nominal data types.

19. The system of claim 15, wherein nominal data comprises variables used to categorize data without any ranking.

20. The system of claim 15, wherein the one or more processors are further configured to smooth the loss function with regard to the output data.
